(19) United States
(12) Patent Application Publication
(10) Pub. No.: US 2023/0314162 A1
(43) Pub. Date: Oct. 5, 2023

(54) MAP GENERATION APPARATUS

(71) Applicant: Honda Motor, Co., Ltd., Tokyo (JP)

(72) Inventor: Naoki Mori, Wako-shi (JP)

(21) Appl. No.: 18/124,518

(22) Filed: Mar. 21, 2023

(30) Foreign Application Priority Data
Mar. 31, 2022 (JP) 2022-058121

(51) Int. Cl. G01C 21/00; G06V 20/56; G06T 7/11; G06T 7/70; G06V 10/44; G06V 10/771

(52) U.S. Cl. CPC G01C 21/3804; G06T 7/11; G06T 7/70; G06V 10/44; G06V 10/771; G06V 20/56; G06T 2207/30252; G06V 2201/07

(57) ABSTRACT

A vehicle control apparatus includes a microprocessor configured to perform: extracting feature points from detection information detected by an in-vehicle detection unit; selecting feature points for which three-dimensional positions are to be calculated from extracted feature points; based on a plurality of detection information, calculating three-dimensional positions of same feature points in the plurality of detection information for the selected feature points using a position and posture of the in-vehicle detection unit; and generating a map including information of each of the three-dimensional positions using the calculated three-dimensional positions of the plurality of the feature points. The selecting includes selecting the feature points so as to reduce a bias in a number of feature points on objects located in a first distance range unit and a number of feature points on objects located in a second distance range farther than the first distance range.

### CROSS-REFERENCE TO RELATED APPLICATION

This application is based upon and claims the benefit of priority from Japanese Patent Application No. 2022-058121 filed on Mar. 31, 2022, the content of which is incorporated herein by reference.

### BACKGROUND OF THE INVENTION

### Field of the Invention

This invention relates to a map generation apparatus configured to generate a map used for estimating a position of a subject vehicle.

### Description of the Related Art

As this type of apparatus, there has been conventionally known an apparatus configured to create maps using feature points extracted from captured images acquired by a camera mounted on a vehicle during driving (see, for example, JP 2020-153956 A).

In the related art technique, the accuracy of map information may be impaired depending on whether the number of feature points on the image to be tracked is greater near or far from the camera.

### SUMMARY OF THE INVENTION

An aspect of the present invention is a vehicle control apparatus including a microprocessor and a memory coupled to the microprocessor. The microprocessor is configured to perform: extracting a plurality of feature points from detection information detected by an in-vehicle detection unit configured to detect a situation around a subject vehicle; selecting feature points for which three-dimensional positions are to be calculated from the plurality of feature points extracted in the extracting; based on a plurality of the detection information, calculating three-dimensional positions of same feature points in the plurality of the detection information for a plurality of the feature points selected in the selecting using a position and posture of the in-vehicle detection unit; and generating a map including information of each of the three-dimensional positions using the three-dimensional positions of the plurality of the feature points calculated in the calculating. The microprocessor is configured to perform the selecting including selecting the feature points so as to reduce a bias in a number of feature points on a plurality of objects located in a first distance range on the in-vehicle detection unit and a number of feature points on a plurality of objects located in a second distance range farther than the first distance range.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system to the embodiment of the present invention;

FIG. 2 is a block diagram illustrating a main configuration of a map generation apparatus according to the present embodiment;

FIG. 3A is a diagram illustrating an example of a camera image;

FIG. 3B is a diagram illustrating extracted feature points;

FIG. 3C is a diagram illustrating feature points associated with a plurality of distance ranges;

FIG. 4A is a diagram illustrating a distribution of feature point;

FIG. 4B is a diagram illustrating the camera image divided into a plurality of groups;

FIG. 5A is a flowchart illustrating an example of processing of processing executed by a controller; and

FIG. 5B is a flowchart illustrating an example of processing of processing executed by the controller.

### DETAILED DESCRIPTION OF THE INVENTION

An embodiment of the present invention will be described below with reference to the drawings.

A map generation apparatus according to the embodiment of the present invention can be applied to vehicles having self-driving capability, that is, self-driving vehicles. Note that the vehicle to which the map generation apparatus of the present embodiment is applied may be referred to as “subject vehicle” to distinguish it from other vehicles. The subject vehicle may be any of an engine vehicle having an internal combustion engine (engine) as a traveling drive source, an electric vehicle having a traveling motor as a traveling drive source, and a hybrid vehicle having an engine and a traveling motor as traveling drive sources. The subject vehicle can travel not only in a self-drive mode in which a driving operation by a driver is unnecessary, but also in the manual drive mode by the driving operation by the driver.

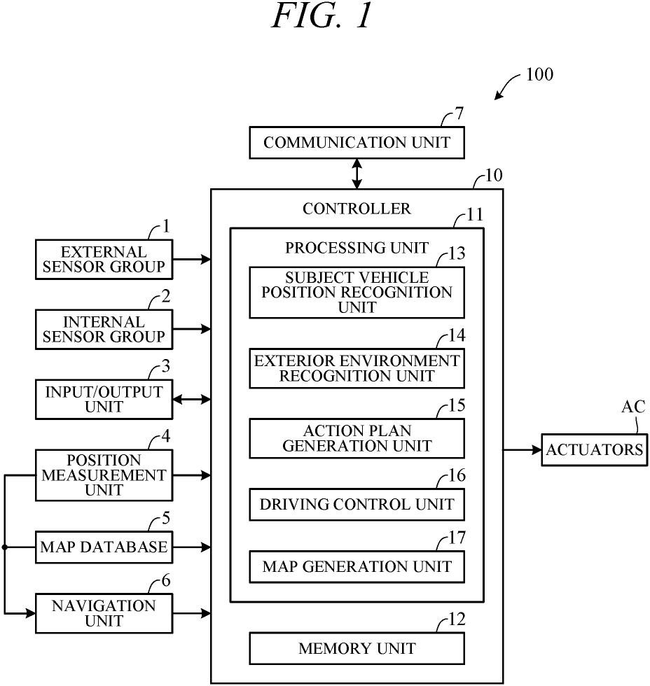

First, a schematic configuration of the subject vehicle related to self-driving will be described. FIG. 1 is a block diagram schematically illustrating an overall configuration of a vehicle control system 100 of a subject vehicle including a map generation apparatus according to the embodiment of the present invention. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and traveling actuators AC each communicably connected to the controller 10.

The external sensor group 1 is a generic term for a plurality of sensors (external sensors) that detect an external situation which is peripheral information of the subject vehicle. For example, the external sensor group 1 includes a LiDAR that measures scattered light with respect to irradiation light in all directions of the subject vehicle and measures the distance from the subject vehicle to surrounding obstacles, a radar that detects other vehicles, obstacles, and the like around the subject vehicle by irradiating electromagnetic waves and detecting reflected waves, and a camera that is installed in the subject vehicle, has an imaging element (image sensor) such as a charge coupled device (CCD) or a complementary metal oxide semiconductor (CMOS), and captures images the surrounding (front, rear, and side) of the subject vehicle.

The internal sensor group 2 is a generic term for a plurality of sensors (internal sensors) that detect a traveling state of the subject vehicle. For example, the internal sensor group 2 includes a vehicle speed sensor that detects a vehicle speed of the subject vehicle, an acceleration sensor that detects an acceleration in a front-rear direction of the subject vehicle and an acceleration in a left-right direction (lateral acceleration) of the subject vehicle, a revolution sensor that detects the number of revolutions of the traveling drive source, and a yaw rate sensor that detects a rotation angular speed around a vertical axis of the center of gravity of the subject vehicle. The internal sensor group 2 further includes a sensor that detects a driver’s driving operation in a manual drive mode, for example, operation of an accelerator pedal, operation of a brake pedal, operation of a steering wheel, and the like.

The input/output device 3 is a generic term for devices in which a command is input from a driver or information is output to the driver. For example, the input/output device 3 includes various switches to which the driver inputs various commands by operating an operation member, a microphone to which the driver inputs a command by voice, a display that provides information to the driver via a display image, and a speaker that provides information to the driver by voice.

The position measurement unit (global navigation satellite system (GNSS) unit) 4 includes a positioning sensor that receives a signal for positioning, transmitted from a positioning satellite. The positioning satellite is an artificial satellite such as a global positioning system (GPS) satellite or a quasi-zenith satellite. The position measurement unit 4 uses positioning information received by the positioning sensor to measure a current position (latitude, longitude, and altitude) of the subject vehicle.

The map database 5 is a device that stores general map information used for the navigation unit 6, and is constituted of, for example, a hard disk or a semiconductor element. The map information includes road position information, information on a road shape (curvature or the like), and position information on intersections and branch points. The map information stored in the map database 5 is different from highly accurate map information stored in a memory unit 12 of the controller 10.

The navigation unit 6 is a device that searches for a target route on a road to a destination input by a driver and provides guidance along the target route. The input of the destination and the guidance along the target route are performed via the input/output device 3. The target route is calculated based on a current position of the subject vehicle measured by the position measurement unit 4 and the map information stored in the map database 5. The current position of the subject vehicle can be measured using the detection values of the external sensor group 1, and the target route may be calculated on the basis of the current position and the highly accurate map information stored in the memory unit 12.

The communication unit 7 communicates with various servers not illustrated via a network including wireless communication networks represented by the Internet, a mobile telephone network, and the like, and acquires the map information, travel history information, traffic information, and the like from the servers periodically or at an arbitrary timing. The travel history information of the subject vehicle may be transmitted to the server via the communication unit 7 in addition to the acquisition of the travel history information. The network includes not only a public wireless communication network but also a closed communication network provided for each predetermined management region, for example, a wireless LAN, Wi-Fi (registered trademark), Bluetooth (registered trademark), and the like. The acquired map information is output to the map database 5 and the memory unit 12, and the map information is updated.

The actuators AC are a traveling actuator for controlling traveling of the subject vehicle. In a case where the traveling drive source is an engine, the actuators AC include a throttle actuator that adjusts an opening (throttle opening) of a throttle valve of the engine. In a case where the traveling drive source is a traveling motor, the traveling motor is included in the actuators AC. The actuators AC also include a brake actuator that operates a braking device of the subject vehicle and a steering actuator that drives a steering device.

The controller 10 includes an electronic control unit (ECU). More specifically, the controller 10 includes a computer including a processing unit 11 such as a CPU (microprocessor), the memory unit 12 such as a ROM and a RAM, and other peripheral circuits (not illustrated) such as an I/O interface. Although a plurality of ECUs having different functions such as an engine control ECU, a traveling motor control ECU, and a braking device ECU can be separately provided, in FIG. 1, the controller 10 is illustrated as a set of these ECUs for convenience.

The memory unit 12 stores highly accurate detailed map information (referred to as high-precision map information). The high-precision map information includes information on the position of roads, road geometry (curvature and others), road gradients, positions of intersections and junctions, types and positions of road division lines such as white lines, number of lanes, lane width and position of each lane (center position of lanes and boundaries of lane positions), positions of landmarks (buildings, traffic lights, signs, and others) on maps, and road surface profiles such as road surface irregularities. In the embodiment, center lines, lane lines, outside lines, and the like are collectively referred to as road division lines.

The high-precision map information stored in the memory unit 12 includes map information (referred to as external map information) acquired from the outside of the subject vehicle via the communication unit 7 and a map (referred to as internal map information) created by the subject vehicle itself using detection values by the external sensor group 1 or detection values of the external sensor group 1 and the internal sensor group 2.

The external map information is, for example, information of a map acquired via a cloud server (referred to as a cloud map), and the internal map information is, for example, information of a map (referred to as an environmental map) including three-dimensional point cloud data generated by mapping using a technology such as simultaneous localization and mapping (SLAM). The external map information is shared between the subject vehicle and other vehicles, whereas the internal map information is map information that is exclusive to the subject vehicle (for example, map information that only the subject vehicle owns). On roads not yet traveled by the subject vehicle, newly constructed roads, and the like, environmental maps are created by the subject vehicle itself. Note that the internal map information may be provided to a server device or other vehicles via the communication unit 7.

In addition to the above-described high-precision map information, the memory unit 12 also stores traveling trajectory information of the subject vehicle, various control programs, and thresholds used in the programs.

The processing unit 11 includes a subject vehicle position recognition unit 13, an exterior environment recognition unit 14, an action plan generation unit 15, a driving control unit 16, and a map generation unit 17 as functional configurations.

The subject vehicle position recognition unit 13 recognizes (or estimates) the position (subject vehicle position) of the subject vehicle on a map, based on the position information of the subject vehicle, obtained by the position measurement unit 4, and the map information of the map database 5.

The subject vehicle position may be recognized (estimated) using the high-precision map information stored in the memory unit 12 and the peripheral information of the subject vehicle detected by the external sensor group 1, whereby the subject vehicle position can be recognized with high accuracy.

The movement information (moving direction, moving distance) of the subject vehicle may be calculated based on the detection values by the internal sensor group 2, and the subject vehicle position may be recognized accordingly. When the subject vehicle position can be measured by a sensor installed on a road or outside a road side, the subject vehicle position can be recognized by communicating with the sensor via the communication unit 7.

The exterior environment recognition unit 14 recognizes an external situation around the subject vehicle, based on the signal from the external sensor group 1 such as a LiDAR, a radar, and a camera. For example, the position, speed, and acceleration of a surrounding vehicle (a forward vehicle or a rearward vehicle) traveling around the subj ect vehicle, the position of a surrounding vehicle stopped or parked around the subject vehicle, the positions and states of other objects, and the like are recognized. Other objects include signs, traffic lights, markings such as division lines and stop lines of roads, buildings, guardrails, utility poles, signboards, pedestrians, bicycles, and the like. The states of other objects include a color of a traffic light (red, green, yellow), and the moving speed and direction of a pedestrian or a bicycle. A part of the stationary object among the other objects constitutes a landmark serving as an index of the position on the map, and the exterior environment recognition unit 14 also recognizes the position and type of the landmark.

The action plan generation unit 15 generates a driving path (target path) of the subject vehicle from a current point of time to a predetermined time ahead based on, for example, the target route calculated by the navigation unit 6, the high-precision map information stored in the memory unit 12, the subject vehicle position recognized by the subject vehicle position recognition unit 13, and the external situation recognized by the exterior environment recognition unit 14. When there is a plurality of paths that are candidates for the target path on the target route, the action plan generation unit 15 selects, from among the plurality of paths, an optimal path that satisfies criteria such as compliance with laws and regulations, and efficient and safe traveling, and sets the selected path as the target path. Then, the action plan generation unit 15 generates an action plan corresponding to the generated target path. The action plan generation unit 15 generates various action plans corresponding to overtaking to pass a preceding vehicle, changing lanes to change traveling lanes, following a preceding vehicle, lane keeping to maintain the lane without deviating from the traveling lane, decelerating or accelerating, and the like. When the action plan generation unit 15 generates the target path, the action plan generation unit 15 first determines a travel mode, and generates the target path based on the travel mode.

In the self-drive mode, the driving control unit 16 controls each of the actuators AC such that the subject vehicle travels along the target path generated by the action plan generation unit 15. More specifically, the driving control unit 16 calculates a requested driving force for obtaining the target acceleration for each unit time calculated by the action plan generation unit 15 in consideration of travel resistance determined by a road gradient or the like in the self-drive mode. Then, for example, the actuators AC are feedback controlled so that an actual acceleration detected by the internal sensor group 2 becomes the target acceleration. More specifically, the actuators AC are controlled so that the subject vehicle travels at the target vehicle speed and the target acceleration. In the manual drive mode, the driving control unit 16 controls each of the actuators AC in accordance with a traveling command (steering operation or the like) from the driver, acquired by the internal sensor group 2.

The map generation unit 17 generates an environmental map of the area around the road on which the subject vehicle has traveled as internal map information using detection values detected by the external sensor group 1 during traveling in the manual drive mode. For example, an edge indicating an outline of an object is extracted from a plurality of frames of camera images acquired by the camera based on luminance and color information for each pixel, and feature points are extracted using the edge information. The feature points are, for example, intersections of edges, and correspond to corners of buildings, corners of road signs, or the like. The map generation unit 17 calculates the three-dimensional position for the feature point while estimating the position and posture of the camera so that the same feature points converge to a single point among a plurality of frames of camera images according to the algorithm of the SLAM technology. By performing this calculation processing for each of the plurality of feature points, an environmental map including the three-dimensional point cloud data is generated.

Note that the environmental map may be generated by extracting feature points of objects around the subject vehicle using data acquired by a radar or LiDAR instead of a camera.

In addition, when generating an environmental map, if the map generation unit 17 determines by pattern matching processing or other means that a predetermined landscape feature (for example, a road division line, traffic light, sign, or the like) having a feature point that was not used to calculate the above-described three-dimensional position is included in camera images, it adds the position information of the point corresponding to the feature point of the landscape feature based on the camera images to the environmental map and records it in the memory unit 12.

The subject vehicle position recognition unit 13 performs subject vehicle position recognition processing in parallel with map creation processing by the map generation unit 17. That is, the position of the subject vehicle is estimated on the basis of a change in the position of the feature point over time. The map creation processing and the position recognition processing are simultaneously performed, for example, according to the algorithm of the SLAM technology. The map generation unit 17 can generate the environmental map not only when the vehicle travels in the manual drive mode but also when the vehicle travels in the self-drive mode. In a case where an environmental map has already been generated and stored in the memory unit 12, the map generation unit 17 may update the environmental map based on newly extracted feature points (which may be referred to as new feature points) from the newly acquired camera images.

By the way, the greater the number of feature points used to generate an environmental map using the SLAM technology, the more accurate the matching between the environmental map and the camera image, and the more accurate the estimation of the subject vehicle position becomes. However, if there are many feature points in the vicinity of the subject vehicle, the estimated position of the subject vehicle becomes correct, but the estimated posture of the subject vehicle lacks accuracy. On the other hand, if there are many feature points far from the subject vehicle, the estimated posture of the subject vehicle is correct, but the estimated position of the subject vehicle lacks accuracy. If either the estimated posture or position of the subject vehicle lacks accuracy, the generated environmental map also lacks accuracy. Therefore, the feature points used for generating the environmental map are preferably distributed over a wide range in the camera image, from near to far from the subject vehicle.

In the embodiment, the same feature points are tracked among a plurality of frames of camera images according to the algorithm of the SLAM technology, the distances to the feature points extracted from the camera images are estimated before the three-dimensional positions of the feature points are calculated, and the number of feature points is adjusted such that the distances to the feature points are distributed over a wide range from near to far from the subject vehicle in the camera image.

The map generation apparatus that executes the above processing will be described in more detail.

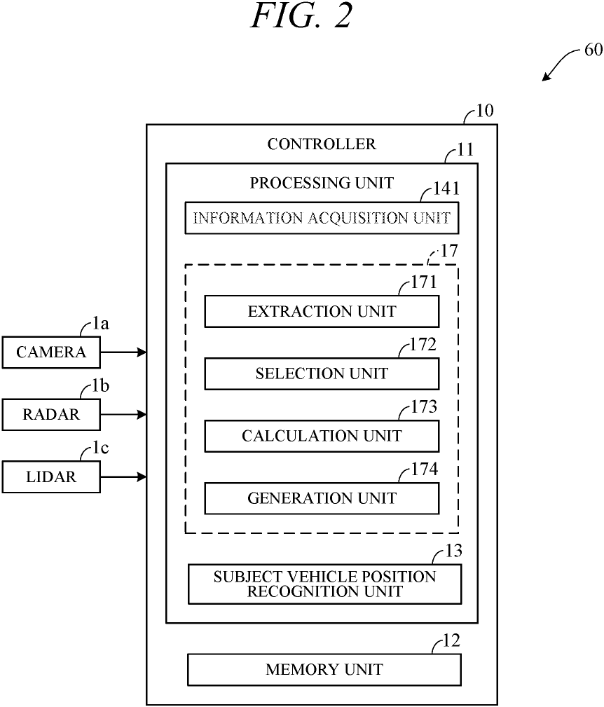

FIG. 2 is a block diagram illustrating a main configuration of a map generation apparatus 60 according to the present embodiment. This map generation apparatus 60 controls the traveling operation of the subject vehicle and constitutes a part of the vehicle control system 100 of FIG. 1. As illustrated in FIG. 2, the map generation apparatus 60 includes the controller 10, the camera 1a, a radar 1b, and a LiDAR 1c.

The camera 1a constitutes a part of the external sensor group 1 of FIG. 1. The camera 1a may be a monocular camera or a stereo camera, and captures images of the surroundings of the subject vehicle. The camera 1a is attached to, for example, a predetermined position at the front of the subject vehicle, continuously captures images of the space in front of the subject vehicle at a predetermined frame rate, and sequentially outputs frame image data (simply referred to as camera images) as detection information to the controller 10.

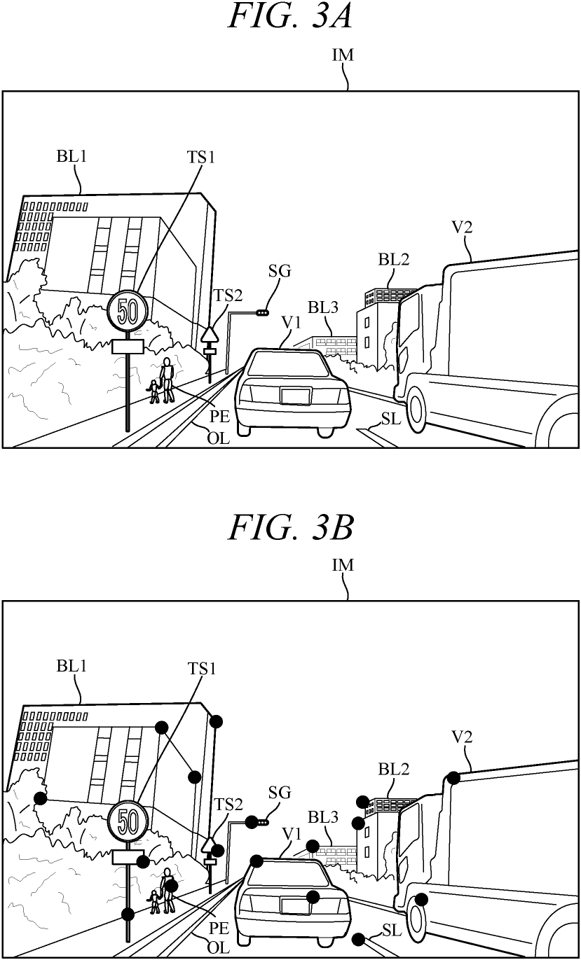

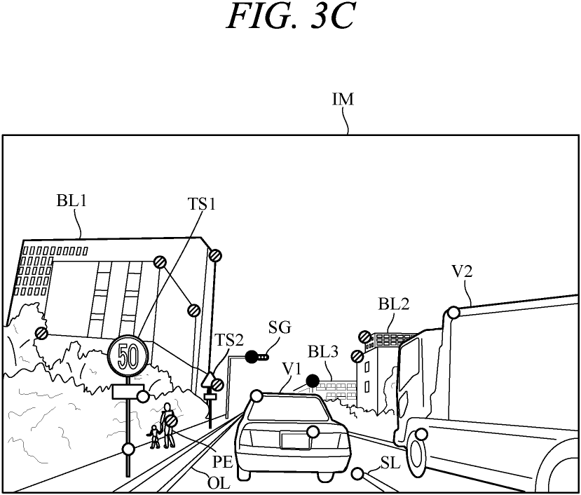

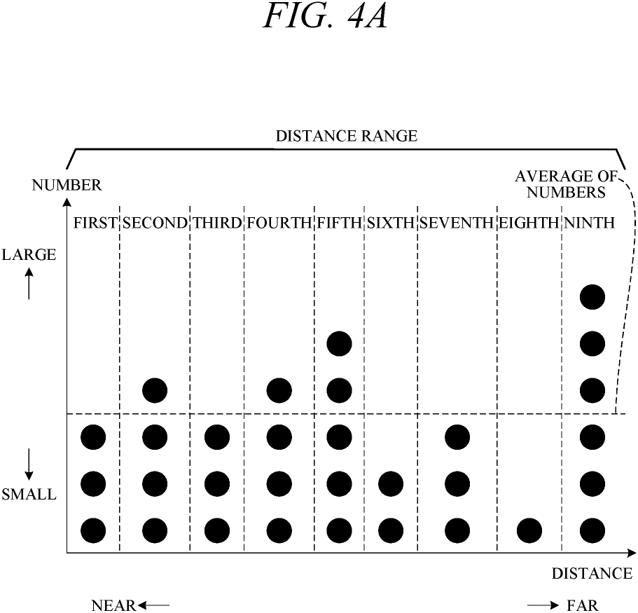

FIG. 3A is a diagram illustrating an example of the camera image of a certain frame acquired by the camera 1a. The camera image IM includes other vehicle V1 traveling in front of the subject vehicle, other vehicle V2 traveling in the right lane of the subject vehicle, a traffic light SG around the subject vehicle, a pedestrian PE, traffic signs TS1 and TS2, buildings BL1, BL2 and BL3 around the subject vehicle, an outside line OL, and a lane line SL.

The radar 1b of FIG. 2 is mounted on the subject vehicle and detects other vehicles, obstacles, and the like around the subject vehicle by irradiating electromagnetic waves and detecting reflected waves. The radar 1b outputs detection values (detection data) as detection information to the controller 10. The LiDAR 1c is mounted on the subject vehicle, and measures scattered light with respect to irradiation light in all directions of the subject vehicle and detects a distance from the subject vehicle to surrounding vehicles and obstacles. The LiDAR 1c outputs detection values (detection data) as detection information to the controller 10.

The controller 10 includes a processing unit 11 and a memory unit 12. The processing unit 11 includes an information acquisition unit 141, an extraction unit 171, a selection unit 172, a calculation unit 173, a generation unit 174, and the subject vehicle position recognition unit 13 as functional configurations.

The information acquisition unit 141 is included in, for example, the exterior environment recognition unit 14 of FIG. 1. The extraction unit 171, the selection unit 172, the calculation unit 173, and the generation unit 174 are included in, for example, the map generation unit 17 of FIG. 1.

The information acquisition unit 141 acquires information used for controlling the driving operation of the subject vehicle from the memory unit 12. In more detail, the information acquisition unit 141 reads landmark information included in the environmental map from the memory unit 12, and further acquires, from the landmark information, information indicating the positions of division lines of the road on which the subject vehicle is driving, and the extending directions of the division lines (hereinafter referred to as division line information).

Note that when the division line information does not include the information indicating the extending direction of the division lines, the information acquisition unit 141 may calculate the extension direction of the division lines based on the position of the division lines. Furthermore, information indicating the position and the extending direction of division lines of the road on which the subject vehicle is driving may be acquired from road map information or a white line map (information indicating the positions of division lines in white, yellow, or other color) stored in the memory unit 12.

The extraction unit 171 extracts edges indicating the contour of an object from the camera image IM (illustrated in FIG. 3A) acquired by the camera 1a, and also extracts feature points using the edge information. As described above, the feature points are, for example, edge intersections. FIG. 3B is a diagram illustrating feature points extracted by the extraction unit 171 based on the camera image IM of FIG. 3A. Black circles in the drawing represent feature points.

The selection unit 172 selects feature points for calculating the three-dimensional position from among the feature points extracted by the extraction unit 171. In the embodiment, unique feature points that are easily distinguishable from other feature points are selected.

First, the selection unit 172 associates the respective feature points extracted by the extraction unit 171 with a plurality of distance ranges based on distance information from the camera 1a to the object including the feature points. FIG. 3C is an example of a diagram illustrating the feature points associated with the three distance ranges. The white circles in the figure indicate feature points associated with the first distance range on the camera 1a side. The hatched circles in the drawing indicate feature points associated with the second distance range farther than the first distance range. The black circles in the figure indicate feature points associated with the third distance range farther than the second distance range.

The distance information from the camera 1a to the object including the feature points is acquired by estimating, based on the position of the object appearing in the camera image IM, the distance in the depth direction from the camera 1a to the object including the feature points with a machine learning technology (for example, deep neural network (DNN)). Note that the distance from the subject vehicle to the object may be calculated based on the detection values by the radar 1b or the LiDAR 1c.

Next, the selection unit 172 selects feature points so as to reduce the bias among the number of feature points on the object located in the first distance range, the number of feature points on the object located in the second distance range, and the number of feature points on the object located in the third distance range. For example, the feature points in other distance ranges are thinned out to reduce their number, thereby bringing the number of feature points in that distance ranges closer to the number of feature points in the distance range with the lowest number of feature points among the plurality of distance ranges. Note that the numbers of feature points in all the distance ranges do not need to be matched, and it is sufficient to reduce the bias in the numbers of feature points among distance ranges.

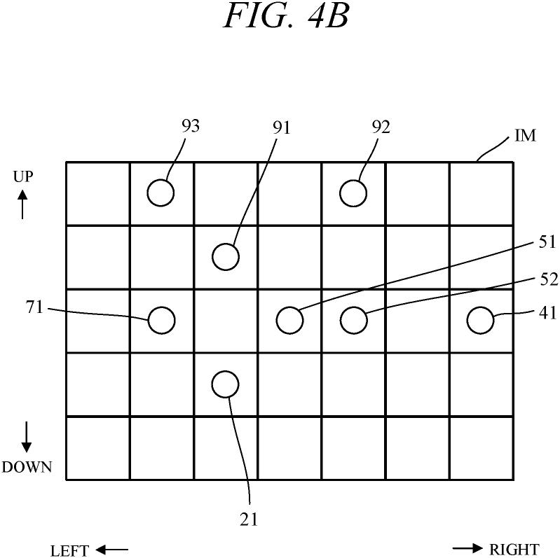

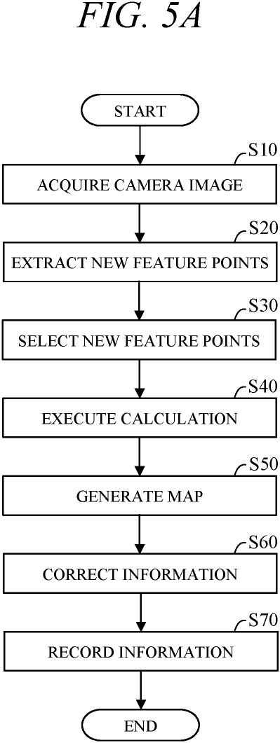

FIG. 4A is a diagram illustrating the distribution of feature points extracted by the extraction unit 171. The horizontal axis indicates the distance from the camera 1a to the object including the feature points, and the vertical axis indicates the number of feature points. The number of distance ranges and the number of feature points illustrated in FIG. 4A are acquired from a camera image different from the camera image IM illustrated in FIG. 3C. In FIG. 4A, 32 feature points are associated with nine distance ranges (first to ninth distance ranges). The horizontal dashed line in the figure indicates the average of the numbers of feature points on the object located in each distance range.

For example, the selection unit 172 thins out a total of eight feature points denoted by reference numerals 21, 41, 51, 52, 71, and 91 to 93 from the second, fourth, fifth, seventh, and ninth distance ranges having more feature points than the average of the numbers of feature points, thereby bringing the number of feature points in these five distance ranges closer to the average. Then, the 24 feature points remaining in the first to ninth distance ranges after the thinning are selected.

Note that the selection unit 172 may execute thinning so that the feature points 21, 41, 51, 52, 71, and 91 to 93 to be thinned out are not biased to some areas in the camera image IM. FIG. 4B is a diagram in which the pixel data constituting the camera image IM is divided into a plurality of groups (for example, 35 rectangular regions obtained by dividing the camera image IM in the horizontal direction (left-right direction in FIG. 4B) and the vertical direction (up-down direction in FIG. 4B)). In FIG. 4B, the circles denoted by reference numerals 21, 41, 51, 52, 71, and 91 to 93 indicate the groups including the feature points to be thinned out in FIG. 4A. By setting the feature points 21, 41, 51, 52, 71, and 91 to 93 each included in different groups as thinning targets, feature points can be thinned out so that the number of feature points to be thinned out is not biased among the groups (not biased among areas in the camera image IM).

The calculation unit 173 in FIG. 2 calculates the three-dimensional position for the feature points while estimating the position and posture of the camera 1a so that the same feature points converge to a single point among a plurality of frames of camera images IM. The calculation unit 173 calculates the three-dimensional positions of the plurality of different feature points selected by the selection unit 172.

The generation unit 174 generates an environmental map including three-dimensional point cloud data including information of each three-dimensional position using the three-dimensional positions of the plurality of different feature points calculated by the calculation unit 173.

The subject vehicle position recognition unit 13 estimates the position of the subject vehicle on the environmental map based on the environmental map stored in the memory unit 12.

First, the subject vehicle position recognition unit 13 estimates the position of the subject vehicle in the vehicle width direction. Specifically, the subject vehicle position recognition unit 13 recognizes the road division lines included in the camera image IM newly acquired by the camera 1a using a machine learning technique. The subject vehicle position recognition unit 13 recognizes the position and the extending direction of the division lines included in the camera image IM on the environmental map based on the division line information acquired from the landmark information included in the environmental map stored in the memory unit 12. Then, the subject vehicle position recognition unit 13 estimates the relative positional relationship (positional relationship on the environmental map) between the subject vehicle and the division line in the vehicle width direction based on the position and the extending direction of the division line on the environmental map. In this manner, the position of the subject vehicle in the vehicle width direction on the environmental map is estimated.

Next, the subject vehicle position recognition unit 13 estimates the position of the subject vehicle in the traveling direction. Specifically, the subject vehicle position recognition unit 13 recognizes a landmark (for example, the building BL1) from the camera image IM (FIG. 3A) newly acquired by the camera 1a by processing such as pattern matching, and also recognizes feature points on that landmark from among feature points extracted by the extraction unit 171. Furthermore, the subject vehicle position recognition unit 13 estimates the distance in the traveling direction from the subject vehicle to the landmark based on the position of the feature point of the landmark appearing in the camera image IM. Note that the distance from the subject vehicle to the landmark may be calculated on the basis of the detection value of the radar 1b or the LiDAR 1c.

The subject vehicle position recognition unit 13 searches for the feature points corresponding to the above landmark in the environmental map stored in the memory unit 12. In other words, the feature point matching the feature point of the landmark recognized from the newly acquired camera image IM is recognized from among the plurality of feature points (point cloud data) constituting the environmental map.

Next, the subject vehicle position recognition unit 13 estimates the position of the subject vehicle in the traveling direction on the environmental map based on the position of the feature point on the environmental map corresponding to the feature point of the landmark and the distance from the subject vehicle to the landmark in the traveling direction.

As described above, the subject vehicle position recognition unit 13 recognizes the position of the subject vehicle on the environmental map based on the estimated position of the subject vehicle on the environmental map in the vehicle width direction and the traveling direction.

The memory unit 12 stores the information of the environmental map generated by the generation unit 174. The memory unit 12 also stores information indicating the traveling trajectory of the subject vehicle. The traveling trajectory is represented, for example, as the subject vehicle position on the environmental map, which is recognized by the subject vehicle position recognition unit 13 during traveling.

### Description of Flowchart

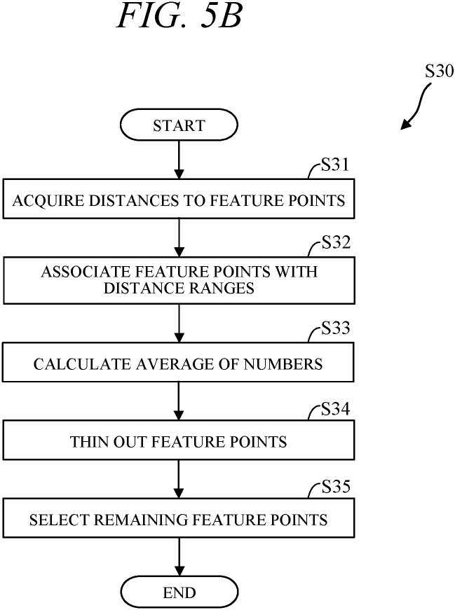

An example of processing executed by the controller 10 of FIG. 2 according to a predetermined program will be described with reference to flowcharts of FIGS. 5A and 5B. FIG. 5A illustrates processing of creating an environmental map, which is started in, for example, the manual drive mode and repeated at a predetermined cycle. FIG. 5B illustrates the details of step S30 of FIG. 5A.

In step S10 of FIG. 5A, the controller 10 acquires the camera image IM as detection information from the camera 1a, and proceeds to step S20.

In step S20, the controller 10 extracts feature points from the camera image IM by the extraction unit 171, and processing proceeds to step S30.

In step S30, the controller 10 causes the selection unit 172 to select feature points, and proceeds to step S40.

In step S40, the controller 10 causes the calculation unit 173 to calculate each of the three-dimensional positions of a plurality of different feature points, and proceeds to step S50.

In step S50, the controller 10 causes the generation unit 174 to generate an environmental map including three-dimensional point cloud data including information of the respective three-dimensional positions of the plurality of different feature points, and proceeds to step S60.

In step S60, if the controller 10 recognizes that the traveling position of the subject vehicle is on the past traveling trajectory, it corrects the information of the three-dimensional position included in the environmental map by loop closing processing, and proceeds to step S70.

The loop closing processing is briefly described below. Generally, the SLAM technique accumulates errors because it recognizes the subject vehicle position while the subject vehicle is moving. For example, when the subject vehicle travels around a looped road such as a ring road, the positions of the start and end points do not match due to accumulated errors. Therefore, when it is recognized that the traveling position of the subject vehicle is on the past traveling trajectory, loop closing processing is executed to make the coordinates of the subject vehicle position recognized using feature points extracted from the camera image newly acquired (referred to as new feature points) at the same traveling point as in the past and the position of the subject vehicle recognized in the past using feature points extracted from the camera image acquired at the past traveling time the same coordinates.

In step S70, the controller 10 causes the memory unit 12 to record the information of the environmental map, and ends the processing according to FIG. 5A.

In step S31 of FIG. 5B, the selection unit 172 acquires the distances to the feature points extracted by the extraction unit 171, and proceeds to step S32. As described above, the distances to the feature points can be estimated as the distance in the depth direction from the camera 1a to the object including the feature points. In addition, it can be calculated based on the detection values by the radar 1b and the LiDAR 1c.

In step S32, the selection unit 172 associates the respective feature points extracted by the extraction unit 171 with a plurality of distance ranges based on the distances to the respective feature points, and proceeds to step S33.

In step S33, the selection unit 172 calculates the average of the numbers of feature points (in other words, the feature point on the object located in each distance range) associated with each distance range, and proceeds to step S34.

In step S34, the selection unit 172 thins out feature points from the distance range having more feature points than the average of the numbers of feature points, and proceeds to step S35.

In step S35, the selection unit 172 selects the feature points remaining in each distance range after the thinning, and ends the processing according to FIG. 5B.

According to the above-described embodiment, the following effects can be achieved.

A map generation apparatus 60 includes: an extraction unit 171 configured to extract feature points from a camera image IM as detection information detected by a camera 1a as an in-vehicle detection unit configured to detect a situation around a subject vehicle; a selection unit 172 configured to select feature points to be used for calculation by the calculation unit 173 (feature points whose three-dimensional position is to be calculated by the calculation unit 173) from a plurality of feature points extracted by the extraction unit 171; a calculation unit 173 configured to calculate, based on a plurality of frames of the camera images IM, three-dimensional positions of the same feature points in the plurality of frames of the camera images IM using the position and posture of the camera 1a for a plurality of different feature points selected by the selection unit 172; and a generation unit 174 configured to generate an environmental map including information of each three-dimensional position using the three-dimensional positions of the plurality of different feature points calculated by the calculation unit 173. The selection unit 172 selects feature points so as to reduce the bias in the numbers of feature points on the plurality of objects located in the first distance range on the camera 1a side and feature points on the plurality of objects located in the second distance range farther than the first distance range.

With this configuration, the distances to feature points used to generate the environmental map (the distance to the object from which the feature points were extracted by the extraction unit 171) are widely distributed in the camera image IM from near to far from the subject vehicle, and the bias in the numbers of feature points between distance ranges is suppressed. Therefore, the accuracy of the estimated posture and position of the camera 1a (subj ect vehicle) at the time of calculating the three-dimensional position of the feature points is secured, whereby an accurate environmental map is generated. In this manner, environmental maps necessary for safe vehicle control can be generated.

In the map generation apparatus 60 of (1), the selection unit 172 thins out feature points from the distance range having more feature points than the average of the numbers of feature points in the first distance range and the number of feature points in the second distance range to bring the number of feature points closer to the average value, and selects feature points remaining after the thinning.

With this configuration, the bias among distance ranges can be suppressed with respect to the number of feature points used to generate environmental maps. Therefore, the accuracy of the estimated posture and position of the camera 1a (subject vehicle) at the time of calculating the three-dimensional position of the feature points is secured, whereby an accurate environmental map is generated.

In the map generation apparatus 60 of (2), the selection unit 172 divides the camera image IM as detection information of the camera 1a into, for example, a plurality of groups of rectangular shape, and thins out feature points from distance ranges having more feature points than the average so that the number of feature points to be thinned out is not biased among the groups.

With this configuration, the bias among distance ranges can be suppressed with respect to the number of feature points used to generate environmental maps. Therefore, the accuracy of the estimated posture and position of the camera 1a (subject vehicle) at the time of calculating the three-dimensional position of the feature points is secured, whereby an accurate environmental map is generated.

In the map generation apparatus 60 of (1), the selection unit 172 thins out feature points from the distance range having a larger number of feature points among the first and second distance ranges to bring the number of feature points closer to the number of feature points in the distance range having a smaller number of feature points, and selects the remaining feature points after the thinning.

With this configuration, the bias among distance ranges can be suppressed with respect to the number of feature points used to generate environmental maps. Therefore, the accuracy of the estimated posture and position of the camera 1a (subject vehicle) at the time of calculating the three-dimensional position of the feature points is secured, whereby an accurate environmental map is generated.

In the map generation apparatus 60 of (4), the selection unit 172 divides the camera image IM as detection information of the camera 1a into, for example, a plurality of groups of rectangular shape, and thins out feature points from distance ranges having a large number of feature points so that the number of feature points to be thinned out is not biased among the groups.

With this configuration, the bias among distance ranges can be suppressed with respect to the number of feature points used to generate environmental maps. Therefore, the accuracy of the estimated posture and position of the camera 1a (subject vehicle) at the time of calculating the three-dimensional position of the feature points is secured, whereby an accurate environmental map is generated.

The above embodiment may be modified into various embodiments. Hereinafter, modifications will be described.

### First Modification

The number of distance ranges and the number of feature points illustrated in FIG. 3C, FIG. 4A, and others are examples, and may be appropriately changed. The number of groups illustrated in FIG. 4B is also an example, and may be appropriately changed.

### Second Modification

In the above description, the selection unit 172 thins out a total of eight feature points denoted by reference numerals 21, 41, 51, 52, 71, and 91 to 93 from the second, fourth, fifth, seventh, and ninth distance ranges having more feature points than the average of the numbers of feature points, thereby bringing the number of feature points in these five distance ranges closer to the average. It may be configured to be closer to the median value instead of the average.

In the second modification, the selection unit 172 thins out the feature points from the distance ranges having more feature points than the median value of the numbers of feature points, thereby bringing the number of feature points in these regions closer to the median value.

According to the second modification, the bias among distance ranges can be suppressed with respect to the number of feature points used to generate environmental maps. Therefore, the accuracy of the estimated posture and position of the camera 1a (subject vehicle) at the time of calculating the three-dimensional position of the feature points is secured, whereby an accurate environmental map is generated.

The above embodiment can be combined as desired with one or more of the above modifications. The modifications can also be combined with one another.

The present invention allows adequate generation of maps necessary for safe vehicle control.

Above, while the present invention has been described with reference to the preferred embodiments thereof, it will be understood, by those skilled in the art, that various changes and modifications may be made thereto without departing from the scope of the appended claims.

What is claimed is:

1. A map generation apparatus comprising:
a microprocessor and a memory coupled to the microprocessor; and
the microprocessor is configured to perform:
extracting a plurality of feature points from detection information detected by an in-vehicle detection unit configured to detect a situation around a subject vehicle;
selecting feature points for which three-dimensional positions are to be calculated from the plurality of feature points extracted in the extracting;
based on a plurality of the detection information, calculating three-dimensional positions of same feature points in the plurality of the detection information for a plurality of the feature points selected in the selecting using a position and posture of the in-vehicle detection unit; and
generating a map including information of each of the three-dimensional positions using the three-dimensional positions of the plurality of the feature points calculated in the calculating, wherein
the microprocessor is configured to perform
the selecting including selecting the feature points so as to reduce a bias in a number of feature points on a plurality of objects located in a first distance range on the in-vehicle detection unit and a number of feature points on a plurality of objects located in a second distance range farther than the first distance range.

2. The map generation apparatus according to claim 1, wherein
the microprocessor is configured to perform
the selecting including thinning out feature points from a distance range having feature points whose number is more than an average of the numbers of the feature points in the first distance range and the number of the feature points in the second distance range so as to bring the number of the feature points in the distance range closer to the average value to select remaining feature points after the thinning.

3. The map generation apparatus according to claim 2, wherein
the microprocessor is configured to perform
the selecting including dividing the detection information into a plurality of groups to thin out the feature points from the distance range having more feature points than the average so that the number of the feature points in the distance range to be thinned out is not biased among the plurality of groups.

4. The map generation apparatus according to claim 1, wherein
the microprocessor is configured to perform
the selecting including thinning out the feature points from the first or second distance ranges which has a larger number of feature points than the other so as to bring a number of feature points in the first or second distance ranges which has the larger number of feature points closer to a number of feature points in the first or second distance ranges which has a smaller number of feature points than the other to select the remaining feature points after the thinning.

5. The map generation apparatus according to claim 4, wherein
the microprocessor is configured to perform
the selecting including dividing the detection information into a plurality of groups to thin out the feature points from the first or second distance ranges which has the larger number of feature points so that the number of feature points to be thinned out is not biased among the plurality of groups.

6. The map generation apparatus according to claim 5, wherein
the in-vehicle detection unit is a camera,
the detection information is a camera image acquired by the camera,
the plurality of groups are a plurality of groups of rectangular shape obtained by dividing the camera image in a horizontal direction and a vertical direction, and
the microprocessor is configured to perform
the selecting including performing thinning of the feature points so that the number of feature points to be thinned out is not biased among the plurality of groups of rectangular shape.

7. A map generation apparatus comprising:
a microprocessor and a memory coupled to the microprocessor; wherein
the microprocessor is configured to function as:
an extraction unit configured to extract a plurality of feature points from detection information detected by an in-vehicle detection unit configured to detect a situation around a subject vehicle; and
a selection unit configured to select feature points for which three-dimensional positions are to be calculated from the plurality of feature points extracted by the extraction unit;
a calculation unit configured to, based on a plurality of the detection information, use a position and posture of the in-vehicle detection unit to calculate three-dimensional positions of same feature points in the plurality of the detection information for a plurality of the feature points selected by the selection unit;
a generation unit configured to use the three-dimensional positions of the plurality of the feature points calculated by the calculation unit to generate a map including information of each of the three-dimensional positions, wherein
the selection unit selects the feature points so as to reduce a bias in a number of feature points on a plurality of objects located in a first distance range on the in-vehicle detection unit and a number of feature points on a plurality of objects located in a second distance range farther than the first distance range.

8. The map generation apparatus according to claim 7, wherein
the selection unit thins out feature points from a distance range having feature points whose number is more than an average of the numbers of the feature points in the first distance range and the number of the feature points in the second distance range so as to bring the number of the feature points in the distance range closer to the average value to select remaining feature points after the thinning.

9. The map generation apparatus according to claim 8, wherein
the selection unit divides the detection information into a plurality of groups to thin out the feature points from the distance range having more feature points than the average so that the number of the feature points in the distance range to be thinned out is not biased among the plurality of groups.

10. The map generation apparatus according to claim 7, wherein
the selection unit thins out the feature points from the first or second distance ranges which has a larger number of feature points than the other to bring a number of feature points in the first or second distance ranges which has the larger number of feature points closer to a number of feature points in the first or second distance ranges which has a smaller number of feature points than the other to select the remaining feature points after the thinning.

11. The map generation apparatus according to claim 10, wherein
the selection unit divides the detection information into a plurality of groups to thin out the feature points from the first or second distance ranges which has the larger number of feature points so that the number of feature points to be thinned out is not biased among the plurality of groups.

12. The map generation apparatus according to claim 11, wherein
the in-vehicle detection unit is a camera,
the detection information is a camera image acquired by the camera,
the plurality of groups are a plurality of groups of rectangular shape obtained by dividing the camera image in a horizontal direction and a vertical direction, and
the selection unit perform thinning of the feature points so that the number of feature points to be thinned out is not biased among the plurality of groups of rectangular shape.
